(19) United States
(12) Patent Application Publication
(10) Pub. No.: US 2026/0147696 A1
(43) Pub. Date: May 28, 2026

(54) METHOD AND DEVICE FOR TESTING A FIRMWARE UPDATE FOR AN EDGE DEVICE

(71) Applicant: Endress+Hauser Process Solutions AG, Reinach (CH)

(72) Inventor: Michael Maneval, Schopfheim (DE)

(21) Appl. No.: 19/121,925

(22) PCT Filed: Oct. 17, 2023
(86) PCT No.: PCT/EP2023/078752

§ 371 Date: Apr. 17, 2025

(30) Foreign Application Priority Data
Oct. 24, 2022 (DE) 10 2022 128 061.6

(51) Int. Cl. G06F 11/3668; G06F 8/61; G06F 8/65

(52) U.S. Cl. CPC G06F 11/3688; G06F 8/61; G06F 8/65

(57) ABSTRACT

A method for testing a new version of a firmware of a connection device that is arranged in an automation system between the field devices and an external server platform, also referred to hereinafter as P system, includes transmitting the new version of the firmware to a test system, hereinafter also referred to as Q system, testing the quality of at least some actions/reactions of the new firmware to simulated events that are modeled on the events occurring in the automation system on the Q system, installing the new version of the firmware by the operating personnel of the automation system on the connection device of the P system if the tested actions/reactions of the new firmware to the simulated events fulfill the quality criteria specified by the system operator on the Q system. Also disclosed is a device suitable for carrying out the method.

The invention relates to a method for testing a new version of the firmware of a connection device that is arranged in an automation system between the field devices of the automation system and an external server platform. Furthermore, the invention relates to a device which is suitable for carrying out the method for testing a new version of a firmware for a connection device.

Field devices that are used in industrial automation technology systems are already known from the prior art. They are used in many areas of process automation and manufacturing automation. In conjunction with the invention, field devices are considered to be all devices which are process-oriented and which provide or process process-relevant information. Field devices record and/or influence-depending on the field of application—physical, chemical or biological process variables of at least one process medium.

Measuring devices, which usually consist of a sensor unit and a measuring transducer unit, are used to record process variables. These are used for example for pressure and temperature measurement, conductivity measurement, flow measurement, pH measurement or fill level measurement, and record corresponding process variables of pressure, temperature, conductivity, pH value, fill level or the flow rate. Actuators, such as valves or pumps, are used for influencing the process variables by which, for example, the flow rate of a liquid in a pipe or the fill level in a container is controlled. In addition to the measuring devices and actuators mentioned above, the term “field devices” also includes remote I/Os, radio adapters, components of the communication network, such as gateways, or—generally speaking—devices that are arranged at the field level or process level in the automation system. The Endress+Hauser Group develops, produces and distributes a large variety of such field devices.

Increasingly, at least one connection device is arranged at the “edge” of an automation technology network, which is referred to as an edge device due to its arrangement. In particular in IIoT environments, an edge device acts as a node between the fieldbus network of automation technology, consisting of a large number of field devices that communicate with each other or with a higher-level control unit via at least one fieldbus protocol, and an external server unit, the IIoT or-generally speaking-the cloud. Depending on the requirements, an edge device provides various interfaces to wired and radio-based transmission technologies and communication standards, such as Ethernet, WLAN or mobile communications such as

The amount of data generated per unit of time by field devices used in automation technology is constantly increasing. In order to evaluate or further process the data in real time or to upload it to the cloud, it makes sense to reduce the amount of data and decide, on site, which data will be processed in the edge device before it is forwarded. The corresponding buzzword to solve this problem is edge computing. Here, decisions are made close to the location where the data is generated as to which data generated by the field devices will be transferred to external server platforms and stored, and which data will be evaluated and reused on site in the edge device. By data processing in real time, an acceptable latency can be achieved, which is important in particular for time-critical applications. In automation technology, for example, it is important that at least one message is reliably received from a field device within a certain period of time. Reliability in the timely delivery of information is a prerequisite for trend formation and/or forecasting. Demand-based data processing enables efficient communication for applications such as predictive maintenance or machine learning. Uploading to the cloud or to an external server platform only occurs when information cannot be evaluated locally, detailed analyses are required or data needs to be archived. This also allows a system operator's costs for using external communication networks to be significantly reduced. Roughly speaking, the edge device is a component with computing and storage resources.

Another advantage that should not be overlooked is that with edge computing the data remains in the system operator's local network. In the field of industrial process automation, sensitive process data is often involved which the system operator does not want to be transmitted over the Internet.

The invention addresses the problem of providing a method and a corresponding device for carrying out the method by which the quality of a new version of the firmware of a connection device is tested in advance.

The problem is solved by a method for testing a new version of a firmware of a connection device, wherein the connection device is arranged in an automation system in the productive system or P system between the field devices of the automation system and an external server platform. The method comprises the following method steps:
the new version of the firmware is transmitted via the Internet or via a network of the automation system to a test system-quality system or Q system-,
the quality of at least some actions/reactions of the new firmware to simulated events that are at least largely modeled on the events actually occurring in the automation system is tested on the Q system before installation on the P system,
the new version of the firmware is installed on the P system by the operating personnel of the automation system if the tested actions/reactions of the new firmware to the simulated events fulfill the quality criteria specified by the system operator on the Q system.

It goes without saying that the firmware of an edge device is continually being developed, for example to add security patches in order to close security gaps, but also to integrate new technical functions or to improve the performance or the functions already integrated into the edge device. In order to avoid system failures or to ensure that no sensitive data leaves the local network without authorization, system operators are highly interested in checking at least certain functions of the new version of a firmware before it is installed in the productive system (P system).

According to the invention, the P system and the Q system are located in the sphere of the system operator.

By means of the method according to the invention, the quality of the new version of the firmware update is tested in the sphere of the system operator before installation on the edge device of the productive system. Testing in the so-called Q system can be carried out on site by the system operator's operating personnel. The method according to the invention makes it possible to detect any security gaps in data communication or a transfer of company data to an external server platform that has not been authorized by the system operator during the test phase. Furthermore, it can be checked whether the field devices of the automation system in communication with the edge device exhibit the behavior they are intended to exhibit. Undesirable behavioral changes in the productive system that the new version of the firmware would cause can be effectively detected in advance. By preliminary testing the firmware of the edge device in the Q system using test data that simulates or corresponds to the quality-critical test functions as realistically as possible, the system operator receives the security required before activating a new firmware. The latter is of course particularly important if the automation system in which the edge device is used must fulfill high security standards regarding the transfer of internal data to the outside world. It is entirely possible that a system operator classifies process data from his automation system as confidential and only wants to make it accessible to a limited group of people. Such data must remain within the sphere of the system operator. Another fear of system operators is that an edge device makes unauthorized changes in the field—for example, that an edge device changes the behavior of a field device in such a way that the automation and thus the product produced undergoes unintended changes.

A development of the method according to the invention provides that software programs are made available to the Q system for the quality assessment of the new version of the firmware, which at least largely simulate individual events that take place in the automation system under real conditions and in which the connection device acts or reacts.

Furthermore, in an embodiment of the method according to the invention, it is proposed to record the data traffic on the connection device of the P system over a specified period of time, wherein during the specified period of time a previous version of the firmware is installed on the connection device of the P system which fulfills the specified quality criteria of the system operator. The recorded data is made available to the Q system as test data for the quality assessment of the new firmware.

Furthermore, a development of the method according to the invention provides that simulation data for the quality assessment of the new version of the firmware, which was generated in an external virtual simulation system that at least in parts simulates the automation system is made available to the Q region.

Alternatively, it is proposed that simulation data for the quality assessment of the new version of the firmware, which was generated in an external simulation system that at least in parts simulates the automation system with real field devices when fulfilling real or simulated measurement or control tasks be made available to the Q system.

In an embodiment of the method according to the invention, it is further suggested that the results of the quality assessment carried out in the Q system are output and displayed to the operating personnel of the automation system.

The new version, according to a development, will be installed on the connection device in the P system if the new version of the firmware sufficiently fulfills the quality criteria used for the quality assessment in the Q system. If the new version of the firmware does not fulfill the quality criteria used for the quality assessment in the Q system or does not fulfill them sufficiently, the installation of the new version of the firmware on the connection device of the P system will be refused.

As already explained in the introduction to the description, the field devices in the automation system fulfill different measuring or control functions depending on the embodiment. Generally speaking, field devices determine physical, chemical or biological process variables of at least one process medium, or they intervene in a controlling manner in the processes that take place in the automation system.

Furthermore, the problem is solved by a device for carrying out the method according to the invention for testing a new version of a firmware of a connection device, wherein the connection device is arranged in the P system in an automation system between the field devices of the automation system and an external server platform. The connection device is assigned a Q system with a test system that is used to check the quality of the new version of the firmware intended for the connection device of the P system, wherein the quality is checked against specified quality criteria. The test system comprises the following components:
a real-time computing unit on which the new version of the connection device's firmware is installed,
a simulation unit that communicates with the real-time computing unit and provides the computing unit with test data, wherein the actions and reactions of the new version of the firmware to the test data provided are used to check whether the firmware fulfills the quality criteria specified by the system operator,
a listener unit that monitors the data traffic between the computing unit and the simulation unit,
an output unit on which the data listened to and possibly further processed by the listener unit is output.

According to a development of the device according to the invention, the connection device is an edge device. The function of an edge has already been described previously.

Furthermore, in conjunction with the device according to the invention, it is proposed that the test system has a communication interface to the Internet, so that the new version of the firmware of the connection device or the edge device is loaded onto the computing unit of the test system via the Internet. For example, the manufacturer of the edge device can provide the system operator with the new version of the firmware on the test system via the Internet. The new version of the firmware will be installed on the test system as soon as the system operator authorizes it.

Alternatively, the test system has a communication interface to a network of the automation system, so that the new version of the firmware of the connection device can be loaded onto the computing unit of the test system via the network and installed there.

One embodiment of the device according to the invention provides an external simulation system in which the automation system is at least partially simulated in reality or virtually. The external simulation system is connected to the test system, in particular to the simulation unit of the test system of the connection device or the edge device, via the Internet. The virtual or real test data is made available directly to the simulation unit.

The quality criteria specified by the system operator can be diverse. They are tailored to the specific requirements of the system operator of the respective automation system. For example, it can be a request to perform a diagnostic method on the field devices, or a request to provide diagnostic data or parameter data from the field devices, or the visualization of the data communication to the external server platform.

The further embodiment of the device according to the invention relates to the design of the communication network in the automation system. Field devices of the automation system that communicate via Ethernet are in direct communication connection with the connection device or the edge device. Field devices that communicate via a fieldbus protocol commonly used in automation technology or via a proprietary fieldbus protocol are in communication connection with the connection device via an intermediate gateway. The gateway is connected between the field devices and the connection device or the edge device.

The invention is explained in greater detail with reference to the following figures, in which:

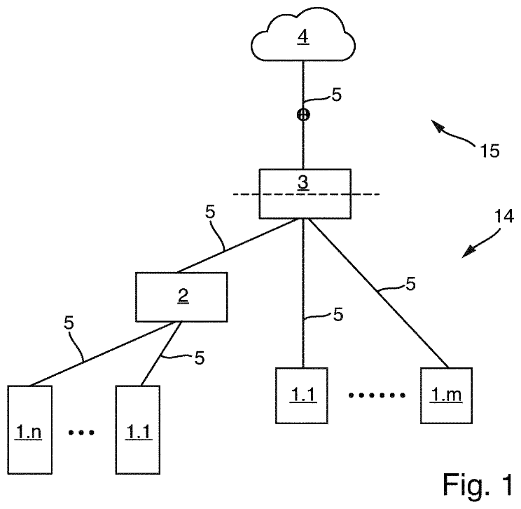

FIG. 1 is a schematic representation of the productive system or P system of an automation system in communication connection with an external server platform,

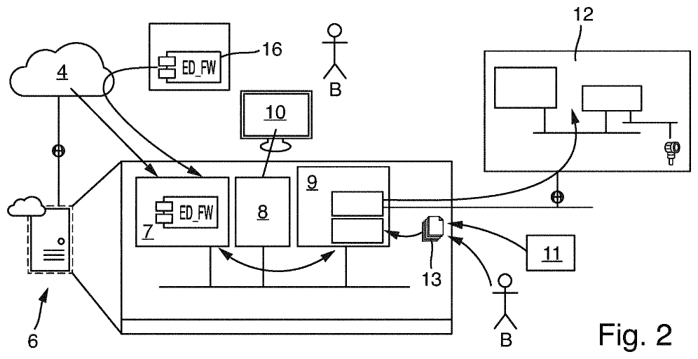

FIG. 2 is a block diagram illustrating different embodiments of the quality system or Q system, and

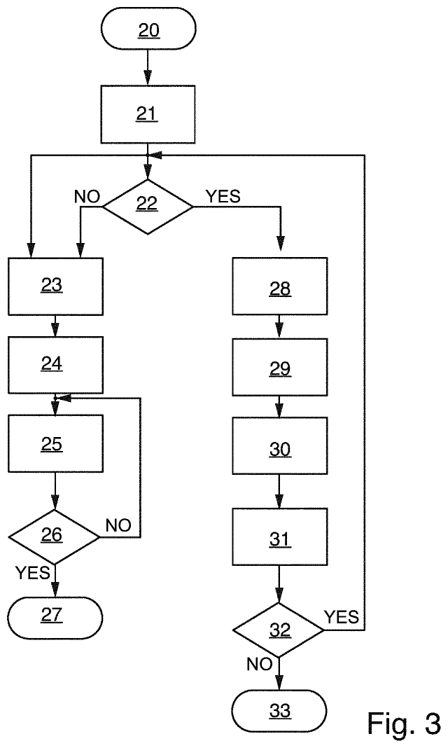

FIG. 3 is a flowchart of an embodiment of the method according to the invention.

FIG. 1 is a schematic representation of field devices 1 of an automation system 14 arranged at the field level, which are in communication connection with an external server or an external server platform 4 via suitable transmission paths 5. The server platform 4 is part of the IIoT 15. The field devices 1.1, . . . 1.n or 1.1, . . . 1.m are measuring devices, actuators or other electronic components of the automation system, which have already been referred to in the introduction to the description. The data exchange between the field level, i.e., a local network, and the IIoT takes place via an edge device 3, the function of which has also already been described above.

Shown in the left area of FIG. 1 are field devices 1.1, . . . 1.n, which communicate via one of the fieldbus protocols commonly used in automation technology, e.g., a HART bus protocol. A gateway 2 communicates with the edge device 3 by transforming the data supplied by the field devices 1.1, . . . 1.n via the fieldbus protocol to an Internet protocol or the data transmitted by the edge device 3 to the fieldbus protocol. The field devices 1.1, . . . 1.m shown in the right-hand area of FIG. 1 already communicate via an Internet protocol, e.g., Ethernet IP, so that the interposition of a gateway 2 is not necessary here.

The dashed line marks the boundary between the field level or the process level, in which the field devices 1 of the automation system 14 are located, and the Internet of Things 15 with the server platform 4 and the server platform 16. The edge device 3 is substantially the gateway from the closed communication sphere of the automation system 14 to the IIoT 15. The edge device 4 must be designed in such a way that it fulfills the respective safety requirements set by a system operator: No unauthorized “data” may pass through this gateway. Furthermore, the edge device 3 must of course not initiate any actions at the field level that in any way disrupt the process flow in the automation system or open a security gap “to the outside.”

Activating a new version of the firmware FW of the edge device 3 undoubtedly represents a potential security risk. It is therefore very important for a system operator to verify critical safety functions of the firmware FW on site using data from the real process system or with data that at least approximately simulates the real process system before the firmware FW is released for installation on the edge device 3.

FIG. 2 shows a block diagram with different embodiments of the quality system or Q system according to the invention. In particular, the test system 6 shown is suitable for preliminary testing a new version of the firmware FW of an edge device 3 for carrying out the method according to the invention. Only if the new version of the firmware FW for the edge device 3 in the Q system fulfills the tested quality criteria will the new version of the firmware FW be installed on the edge device 3 in the productive system or P system. In general, the edge device 3 can also be described as a connection device between a local automation technology network and the Internet, in particular a server platform or the Industrial Internet of Things-IIoT. The test system 6 is located in the local network or sphere of the system operator. The new version of the firmware FW for the edge device 3 is produced in the local network or in the sphere of the manufacturer/supplier and is transmitted from a server 16 via the Internet to the test system 6 of the system operator and installed there.

The test system 6 is used for the preliminary check of the quality of a new version of the firmware FW for the connection device 3, wherein the quality of the actions and reactions of the edge device 3 is assessed on site with regard to quality criteria defined by the system operator. The test system 6 has a real-time computing unit 7, a listener unit 8 and a simulation unit 9. The new version of the firmware FW of the edge device 3 is installed on the real-time computing unit 7. The simulation unit 9 is in communication connection with the real-time computing unit 7 via Ethernet IP. Test data is made available to the computing unit 7, wherein the actions and reactions of the new version of the firmware FW of the edge device 3 to the test data are used to check whether the firmware FW fulfills the quality criteria specified by the system operator.

The results of the check must be verifiable by the system operator. Therefore, the decision regarding the correct functioning of the edge device 3 with the new firmware FW is made on site in the sphere of the system operator. The data traffic between the computing unit 6 and the simulation unit 8 is monitored by means of a listener unit 7. The listener unit 8 is connected to an output unit 10 on which the data listened to and possibly further processed by the listener unit 8 is output—in response to the test data specified by the system operator. The data displayed is checked by appropriately trained operating personnel BP for congruence with the specifications of the system operator and is subsequently accepted or rejected.

The test data itself can be generated in different ways. These may be software programs 13 that at least largely simulate the actions or reactions of the edge device 3 that occur in the automation system under real conditions. Based on the data/information shown on the display unit 10, the operating personnel BP can decide whether the actions/reactions are to be carried out by the edge device 3 in the manner defined by the system operator.

An alternative method for generating the test data involves recording the data traffic on the edge device 3 installed in the automation system 14 over a specified period of time. The specified period of time is such that all actions/reactions that need to be checked for quality occur during the period of time. At the time of recording, the accepted previous version of the firmware FW is still installed on the productive edge device 3, which fulfills the quality requirements of the system operator. The recorded test data is made available to the real-time computing unit 7 of the test system 6 for the quality assessment of the new firmware FW. This makes it possible to determine whether the critical actions/reactions are handled the same or differently by the new version of the firmware FW of the edge device 3. Based on the type of deviation, the operating personnel decides whether the safety criterion for release is fulfilled or not.

Another variant for providing test data suggests that the test data is simulation data that was generated in an external virtual simulation system 12 that at least in parts replicates the real automation system 14. Alternatively, the test system 6 is provided with simulation data that was generated in an external, real simulation system 12 that at least in parts simulates the automation system 14 with real field devices 1.

FIG. 3 is a flowchart of an embodiment of the method according to the invention. The method starts at point 20. The new version of the firmware FW of the edge device 3 is developed under the responsibility of the manufacturer of the edge device 3. The new version of the firmware FW is transmitted via the Internet to the company network of the automation system 14. Depending on whether a test system 6 for the new version of the firmware FW is available or not (point 22), the method splits into two branches.

If no test system 6 is available, the new version of the firmware FW is provided to the edge device 3 (point 23) and installed on the edge device 3 at point 24. This is always common practice when there is an unrestricted relationship of trust between the system operator and the manufacturer. It goes without saying that all important functions of the new version of the firmware FW have already been checked by the manufacturer. The firmware FW then performs its functions, such as reading measurement or control data and process data from the automation system 14 and transmitting the data, if necessary in processed form, to an external server platform 4 (point 25). The functions to be fulfilled under point 25 are continuously executed by the edge device 3 until the edge device 3 is shut down (point 26). The method ends at point 27.

If, for safety reasons, a Q system is to be used to check the quality of the new version of the firmware FW, the firmware FW is transmitted to the test system 6 via the Internet (point 28) and installed on the real-time computing unit 7 of the test system 6 under point 29. Real or simulated measurement or process data is made available to the firmware FW to check safety-critical functions of the edge device 3. In order to check which data leaves or enters the sphere of the system operator, the corresponding data communicated to a test cloud is evaluated. This evaluation and, if necessary, authorization is carried out by the operating personnel B of the automation system 14. The data relating to critical functions of the edge device 3 is presented on an output unit 10, in particular a display unit, and manually authorized or rejected by the operating personnel B (points 30, 31).

This process is repeated until all results of the data of the tested safety-critical functions of the edge device 3 in the automation system 14 have been checked. Only if the test results provide the expected information that complies with the system operator's safety requirements (point 32) is the new version of the firmware FW installed on the edge device 3 of the automation system 14 (point 23)—only then does it enter the P system. If one of the functions of the new version of the firmware FW that the system operator classifies as safety-critical is rejected, the firmware FW will not be put into production and the test method will be terminated at point 33.

By means of the test method according to the invention, the system operator is given the necessary security required to accept the downloading and installation of a new version of the firmware FW of an edge device 4 via the Internet. The test method makes everything that the system operator wants to know transparent. After the check, it is transparent, for example, which diagnostic data is requested from the field devices 1, how the requested data is interpreted, which test routines are carried out and which data is uploaded to the Internet.

### LIST OF REFERENCE SIGNS

1 Field device
2 Gateway
3 Edge device/connection device
4 External server platform
5 Communication connection
6 Test system/Q system
7 Real-time computing unit
8 Listener unit
9 Simulation unit
10 Output unit/display unit
11 Simulation system
13 Software program
14 Automation system
15 IIoT
16 Server

1-15. (canceled)

16. A method for testing a new version of a firmware of a connection device, wherein the connection device is arranged in an automation system between field devices of the automation system and an external server platform, the method comprising:
transmitting the new version of the firmware via an Internet or another network to a quality system, wherein the quality system is assigned to the automation system;
testing a quality of at least some actions/reactions of the new firmware to simulated events that are at least largely modeled on events actually occurring in the automation system in the quality system before installation on the automation system;
installing the new version of the firmware on the connection device of the automation system if the actions/reactions of the new firmware to the simulated events tested in the quality system fulfill quality criteria specified by a system operator.

17. The method according to claim 16, further comprising:
providing the quality system with simulation rules in the form of software programs for a quality assessment of the new version of the firmware, which at least largely simulate individual events that take place in the automation system and in which the connection device acts or reacts.

18. The method according to claim 16, further comprising:
recording data traffic on the connection device in the automation system over a specified period of time, wherein during the specified period of time a previous version of the new version of the firmware is installed on the connection device, which fulfills the specified quality criteria of the system operator, and
making available to the quality system the data of the recorded data traffic as test data for the quality assessment of the new version of the firmware.

19. The method according to claim 16, further comprising:
providing the quality system with simulation data for the quality assessment of the new version of the firmware, which was generated in an external virtual simulation system which is simulated at least in parts of the automation system.

20. The method according to claim 16, further comprising:
providing the quality system with simulation data for the quality assessment of the new version of the firmware which was generated in an external real simulation system which is simulated at least in parts of the automation system with real field devices when fulfilling real or simulated measurement or control tasks.

21. The method according to claim 16, further comprising:
outputting and displaying to the operating personnel of the automation system the results of the quality assessment carried out in the quality system.

22. The method according to claim 21, further comprising:
installing the new version of the firmware on the connection device in the automation system if the new version of the firmware sufficiently fulfills the quality criteria used for the quality assessment in the quality system, or
refusing the installation of the new version of the firmware on the connection device of the automation system if the new version of the firmware does not fulfill, or does not sufficiently fulfill, the quality criteria used for the quality assessment in the quality system.

23. The method according to claim 16,
wherein at least one process variable of a process medium is determined or controlled by each of the field devices in the automation system.

24. A test system for testing a connection device which is arranged in an automation system with a plurality of field devices between the field devices of the automation system and an external server platform, wherein the connection device is assigned to the test system which serves to check the quality of the a version of firmware intended for the connection device, wherein the quality is checked with regard to specified quality criteria, the test system comprising:
a real-time computing unit on which the new version of the firmware of the connection device is installed;
a simulation unit that communicates with the real-time computing unit and provides the real-time computing unit with test data, wherein actions and reactions of the new version of the firmware to the test data provided are used to check whether the firmware fulfills the quality criteria specified by the system operator;
a listener unit that monitors the data traffic between the computing unit and the simulation unit;
an output unit on which the data listened to and possibly further processed by the listener unit is output.

25. The test system according to claim 24,
wherein the connection device is an edge device.

26. The test system according to f claim 25,
wherein the test system has a communication interface to the Internet, and
wherein the new version of the firmware of the connection device is loaded onto the real-time computing unit of the test system via the Internet.

27. The test system according to claim 25,
wherein the test system has a communication interface to a network of the automation system, and
wherein the new version of the firmware of the connection device is loaded onto the computing unit of the test system via the network.

28. The test system according to claim 27,
wherein an external simulation system is provided, in which the automation system is at least partially simulated in real or virtual form, and
wherein the external simulation system is connected to the simulation unit of the test system via the Internet.

29. The test system according to claim 24, wherein the quality criteria relate to an execution of diagnostic methods on the plurality of field devices or to the request for diagnostic data or parameter data from the plurality of field devices.

30. The test system according to claim 29,
wherein field devices of the plurality of field devices of the automation system communicating via Ethernet are in direct communication connection with the connection device or the edge device, while field devices of the plurality field devices that communicate via a fieldbus protocol commonly used in automation technology or a proprietary fieldbus protocol communicate via a gateway with the connection device that is connected between the field devices and the connection device or the edge device.
